(19) United States
(12) Patent Application Publication
(10) Pub. No.: US 2008/0059933 A1
(43) Pub. Date: Mar. 6, 2008

(54) Method and System for Designing Fan-out Nets Connecting a Signal Source and Plurality of Active Net Elements in an Integrated Circuit

(75) Inventors: Erich Barke, Hannover (DE); Markus Buehler, Weil im Schoenbuch (DE); Juergen Koehl, Weil im Schoenbuch (DE); Markus Olbrich, Langenhagen (DE); Philipp Panitz, Garbsen (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/845,892

(22) Filed: Aug. 28, 2007

(30) Foreign Application Priority Data
Aug. 29, 2006 (EP) 06119667.1

(51) Int. Cl. G06F 17/50

(52) U.S. Cl. 716/13

(57) ABSTRACT

The present invention relates to a method for designing fan-out nets connecting a signal source and a plurality of net elements in an integrated circuit. In order to make fan-out nets more robust against opens while keeping the risk due to short circuits in an acceptable degree, the method comprises the steps of: a) implementing a routing section in a closed structure comprising a plurality of signal receiving pins, wherein said receiving pins connect to further net elements, b) implementing on said closed structure a plurality of buffer elements to provide multiple signals derived from said source signal for driving said plurality of net elements, and c) limiting the distance and number of receiving cells between two buffer elements below predetermined values in order to keep a short circuit current given in case of an open tolerably small and within a worst case skew time delay.

### BACKGROUND OF THE INVENTION

1. Field of the Invention

The present invention relates to the manufacturing of integrated circuits, and in particular to a method for designing fan-out nets between a signal source and a plurality of net elements connected to the source.

2. Description and Disadvantages of Prior Art

In modern chip design (VLSI) so-called Steiner trees are used as a prior art architectural means for building above-mentioned fan-out nets, connecting between a signal source and a plurality of signal sinks. Steiner trees offer a network geometry having the shortest wiring for interconnecting between source and sinks. Steiner trees offer a good geometry to avoid shorts and keep the capacity of fan-out nets small. The physical size of electrical circuit features such as wiring, and switching circuit elements is decreasing continuously.

With decreasing feature size, opens become more and more important as functional yield detractors in chip wiring. Yield loss is directly related to the revenue of semiconductor companies. Additionally, the variation of electrical parameters increases with every new technology node due to manufacturing variations. Variations of electrical parameters lead to timing uncertainty and can result in parametric yield losses.

In addition to general shrinking effects, the major yield detraction mechanisms shift from shorts to opens with the change from aluminium wiring to copper wiring. The reason lies in an important change of the manufacturing process: In aluminium technologies one first covers the entire chip with an aluminium layer and then etches unnecessary aluminium, leaving the desired wiring structures. A particle that lands on the chip during the etching process leads to a short. In copper however, the process is different: First the entire chip is covered by a silicon dioxide (SiO₂) layer. Then the wiring channels are etched into the SiO₂ layer and filled with copper. This process is obviously more sensitive to opens.

A known solution to the problem of opens in chip wiring is the augmentation of Steiner trees as for example published in “Nontree routing for reliability and yield improvement”

Keg, A. B.: Bao Liu; Mandoiu, I. I.; IEEE Transactions of Computer-Aided-Design of Integrated Circuits and Systems; January 2004 Pages: 148-156. Given a traditional routing tree the Khang approach adds additional wiring segments to the tree to build loops. Thus, a so-called “non-tree routing architecture is introduced, wherein a chip would still be functional if a single open in a loop occurs. In the above publication it is shown that this approach works more efficient for high fan-out nets, wherein a single source drives all signal sinks.

In high performance designs, however, there are a large number of high fan-out trees which are implemented as buffer or inverter trees, generally known as repeater trees. This repeater tree implementation decomposes a large fan-out net into a set of smaller nets which propagate the same logical signal or its inverse. The approach proposed by Khang could be used to add redundancy to each of these nets, but the redundancy provided by the fact that each of these nets carries the same signal is not exploited by this approach. For example, a fail in the driving circuit of one of these nets destroys the chip. Thus, the Khang approach is not suited prima facie to be applied in those repeater nets.

Another drawback of the tree augmentation approach according to Khang is that the size of the loops cannot be controlled.

FIG. 1 shows a routing tree having a plurality of segments with an augmenting link 9 connecting between signal sinks 5 and 7. The loop generated by this link is shown denoted with reference sign 8. If an open denoted 6 disconnects the loop at the marked segment the driving pin 2 will drive a long chain with pins. The result is a long signal delay from the driving pin 2 to some of the receiving pins, for example pin 3, which may result in a soft fault hence parametric yield will decrease.

If there is a relatively large loop and if this loop is disconnected somewhere close to the point where the signal is injected into the loop there will emerge a long chain from the loop with a large number of pins connected to it. This is shown for the loop 8 in FIG. 1. The open indicated by line 6 ‘/’ would increase the RC delay to the sinks on the left of the source considerably. This may violate timing constraints of the design. Additionally, the tree augmentation approach according to Khang cannot guarantee a worst case delay in the fault case.

### OBJECT OF THE INVENTION

It is thus an object of the present invention to provide a design method which makes the above mentioned fan-out nets more robust against opens while keeping the risk due to shorts in an acceptable degree.

### SUMMARY AND ADVANTAGES OF THE INVENTION

This object of the invention is achieved by the features stated in enclosed independent claims. Further advantageous arrangements and embodiments of the invention are set forth in the respective dependent claims. Reference should now be made to the appended claims.

According to the broadest aspect of the invention a method is disclosed for designing fan-out nets in an integrated circuit, wherein the fan-out nets are connecting a signal source and a plurality of active net elements around the source pin in order to provide multiple signals derived from said source, the method characterized by the steps of:

implementing a routing section in a closed structure comprising a plurality of signal receiving pins, wherein the receiving pins connect to further active elements,

implementing on this closed structure a plurality of buffer elements—in a rectangular wiring the buffer elements preferably being located on a Manhattan circle—around the source pin to provide multiple signals derived from said source signal for driving said plurality of active elements, and

locating two buffer elements at a distance from each other along connective wiring greater than a predetermined minimum wiring length in order to keep a short circuit current tolerably small.

Further, of course, an upper limit has to be satisfied for driving said plurality of active net elements, which will be later discussed with reference to FIG. 2.

Under “closed structure” a ring-like structure is understood, which is generally not “round” but can comprise straight wiring or curved wiring, and can include or exclude “satellite” pins electrically connected to it via an appendix-like one-way wiring direction, see Appendix of FIG. 2.

The timing of a chip that is treated with this technique can be evaluated using static timing analysis. A correct setting of the wiring distance leads to predictable timing even in the case of an open.

With this method it is possible to feed the signal into the loop 8 of FIG. 1 at multiple points making the switching structure much more robust. According to the abovementioned Khang approach the fan-out nets are treated as if they were propagating different signals. The resulting structure uses the signal redundancy in these trees to improve the robustness to manufacturing defects.

### BRIEF DESCRIPTION OF THE DRAWINGS

The present invention is illustrated by way of example and is not limited by the shape of the figures of the drawings in which:

FIG. 1 is a schematic diagram of a routing tree augmented by an additional wiring bridge connecting between some tree leaves and thus forming a loop thereof;

FIG. 2 is a schematic diagram illustrating the provision of multiple buffers connected to the signal source in accordance with the present invention;

FIG. 3 is a schematic diagram illustrating the provision of multiple buffers connected to the signal source in two iterated buffer stages in accordance with the present invention;

FIG. 4 is a control flow diagram comprising steps of a method in accordance with the present invention;

FIG. 5 illustrates a test case having 34 sinks surrounding a signal source and being interconnected:

FIGS. 6A and 6B are the continuation of FIG. 5 illustrating a Manhattan circle around the source comprising 9 repeater devices for optimized signal distribution to the sinks, 6A for rectangular routing 6B for rectangular and diagonal routing;

FIG. 7 is a map showing simulation of short circuit current over time and depicting the worst case currents through a transistor dependent on the skew (the timescale is 100 ps per scale unit between two dotted lines);

FIG. 8 is a graph of a simulation of current over time, wherein the current flowing through a wire that connects a cluster of early and a cluster of late switching inverters (the timescale is 2 ns per scale unit between two dotted lines); and

FIG. 9 is a table illustrating the additional power dissipation caused by varying signal arrival times at the inverter inputs.

### DESCRIPTION OF THE PREFERRED EMBODIMENT

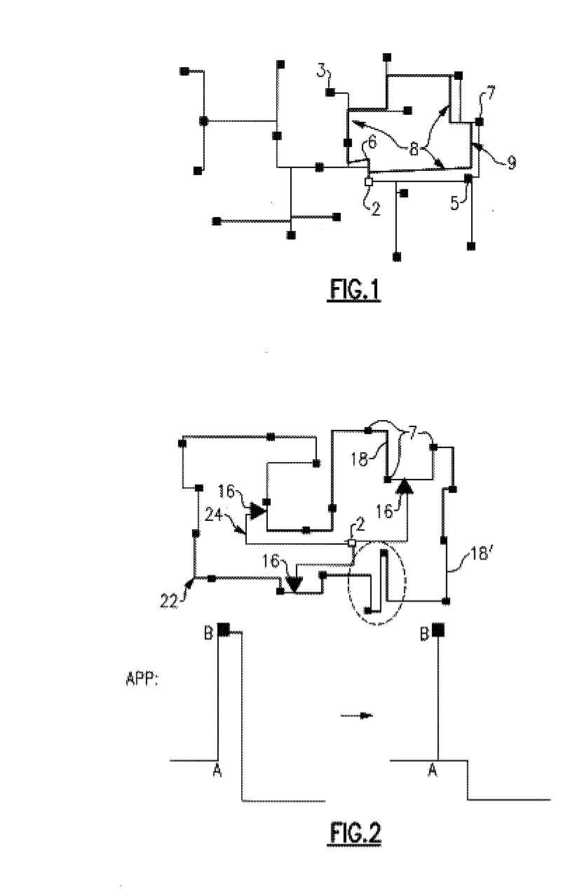

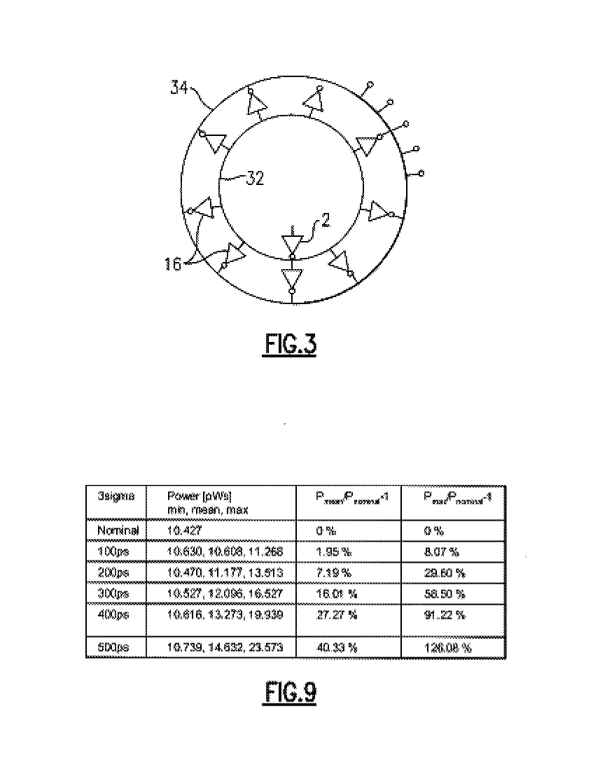

With general reference to the figures and with special reference now to FIG. 2, a basic aspect of the invention is applied in a copper technology chip. In the example shown in FIG. 2, different nets carrying the same signal are connected to achieve robustness against open defects. A loop is used to help to protect the wiring of the exemplary net against a single open. This circular structure, “closed” (in the above sense) structures, is applied in a way which satisfies the electrical conditions of the net.

Further, a plurality of buffer elements 16 is connected to a signal source 2 in order to drive the sinks 7 connecting in turn to other receiving circuits (not depicted). Instead of allowing only one driving cell per net as known from above Khang publication, according to the invention now multiple repeater circuits are added driving a loop through all receiving circuits. The signal is distributed over an inner tree 24 to the buffers 16 that drive the outer loop connecting all sinks 7 provided in form of receiving pins. In this case the number of pins connected by the loop becomes larger then in the case of a single net, and the loops can be inserted more efficiently with respect to additional wire length.

A worst case delay that occurs if an open disconnects the loop close to a repeater 16 (buffer) output can be limited by limiting the distance 18, 18′ and number of receiving pins 7 between two of said repeater outputs 16.

In FIG. 2 the wiring length between two repeater outputs is below 500 micrometers; assuming a wiring cross section of 50 femtosquaremeters a total capacitance of the whole wiring 18 is 80 femtoFarad (values taken from prior art IBM 130 nm technology on metal layer M4). It should be noted that a predetermined minimum capacitance should be provided by the wiring 18 in order to receive the electrical load in case of a short circuit during the skew time delay.

Applying this technique will lead to increased timing certainty even in the fault case. Further, and with reference still to FIG. 2, an upper limit length between two adjacently located buffers 16 has to be satisfied for the following reasons: First, the drivers 16 can only drive a maximum capacitance, and a long interconnect to the next buffer element on the circle could exceed the maximum capacitance. Second, if the connection between one of the sinks 7 close to a buffer element 16 has an open, this sink now has to be driven by the next closest buffer element 16, which will result in an increased delay to this sink. Limiting the distance between the buffer elements 16 also limits the timing change in the case of an open.

The appendix at the bottom of FIG. 2 is given to illustrate, that the term “closed structure” also includes variants of the structure—in particular abbreviated forms thereof—, where wiring subsections are present which allow only one connection from a point A to a point B, instead of at least two (clockwise, and counter-clockwise along the ring contour).

With reference to FIG. 3 the method in accordance with the invention is preferably applicable also for multiple buffer stages. The driving circuit depicted in FIG. 3 drives an inner loop 32 which distributes the signal from source 2 to several buffers 16 which are driving an outer loop 34. Using this basic technique in a cascaded manner by doing iterations of this scheme it is possible to build a hierarchical network that provides thousands of sinks with the signal while keeping the circuit robust against opens as the net built up so far withstands a single disconnection or failure anywhere in the net even in the active devices.

Another important aspect of survivability is that the loop is driven by multiple signal sources. That means even in the case of an open the increase in path delay is small.

Usually clock nets and reset nets have such a high fan-out and are thus a preferred application for the method. Another advantage is that the skew of the final stage is reduced due to the connected driver outputs of previous levels. This application is especially interesting for the design of clock nets where minimal skew is a design objective.

Experimental results also show that the method provides circuits having less delay and being more robust with respect to delay variation compared to the prior art tree routing approach.

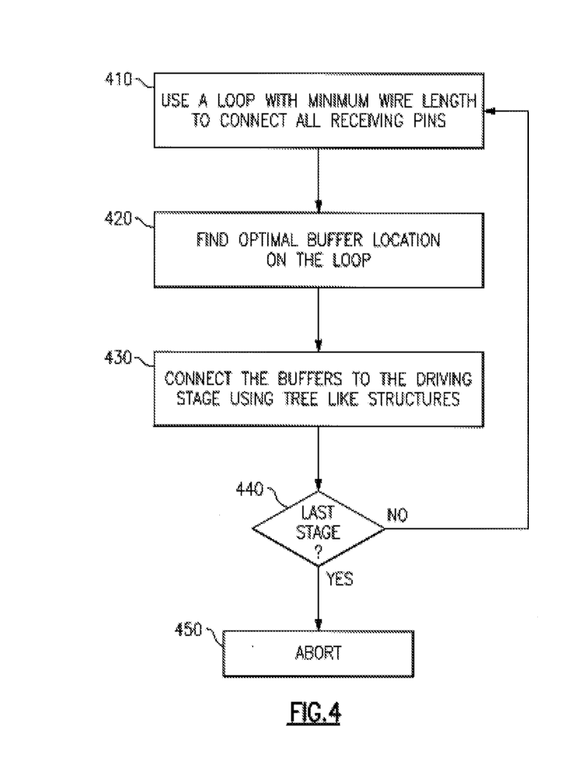

With reference to FIG. 4 a sequence of steps and the control flow of a preferred embodiment of a method in accordance with the invention will be described:

In a first step 410 a minimum wire length loop is created that connects all receiving pins. This is done applying a “travelling salesman problem” (TSP) heuristic in a prior art circuit design tool.

The next step 420 is to evenly distribute enough repeaters 16 on the loop to drive the load. For the repeaters 11 optimal locations should have to be found. Optimal in this context means “reachable from the driving stage with the shortest wire length possible”. Additionally, the wire length from the driving stage to each receiving input has to be kept balanced in a certain range.

With additional reference to FIG. 9 illustrating the additional power dissipation caused by varying signal arrival times at the inverter inputs, it takes 100 ps of skew at the input of the driving cells to establish a short circuit current that leads to an additional power dissipation of 2%.

An upper bound on the wire length can be given with respect to a certain technology. If the difference is kept below 100 μm the skew target is met. A certain capacitance and resistance between the repeaters 16 is important to minimize short circuit currents it the repeaters switch at different times (skew). A certain amount of wire length between the repeater outputs delays the establishment of a short circuit current. As the connection of repeater outputs is a design technique to reduce unintentional skew, the optimal wire length is a result of this trade off. It is dependent on a specific technology and can be obtained by simulation. A feasible range of wire length is 200 um-800 um.

By applying an upper bound on the wire length and the value of input capacitance of the receiving circuits between two inverter outputs the worst case delay can be restricted. The minimum wiring portion length limit and the minimum capacitance limit of the wiring portions can be obtained by simulation.

In an example of copper technology the following parameters should be kept as an orientation for limiting values;

vdd=1.2-1.5V (positive power supply voltage)

T=100° C.

wiring crossection=50*10⁻¹⁵ m²

C/length=168 fF/micrometer

As it is described later a generic test case was set up as depicted in FIG. 5. Under the assumption that the signal source 2 can be connected to the receiving repeaters applying balanced routes a worst case skew calculation yields 40.9 ps skew. For that special test case the expected additional power dissipation due to variation can be determined by lookup in the table depicted in FIG. 9. It will be below 2%.

The next step 430 is to connect the buffers 16 to the driving pin using a tree like structure. There has to be more than one signal path from the signal source to the loop. This approach also works for more than one buffering stage. Assume that the receiving pins in the loop are the inputs of the next inverter stage and deliver their signals to the next loop using a routing tree as wiring network. Note that the loops have to be designed bottom up. First the sinks have to be connected using a loop. Then the buffer stages can be inserted in an optimal way.

If this method is repeated iteratively, a decision 440 yields, if the current stage was the last stage. In the NO-branch the method is repeated one level higher. Otherwise the method will be finished.

With reference to FIGS. 5 to 8 and table 1 the results on a generic test case are described in order to demonstrate the feasibility of the method.

A generic test case was set up to provide some results on the currents flowing from Vdd to Gnd (Ground) and on the additional power dissipation. To model a large global net a number of 34 receiving pins were randomly distributed on a 1000 μm×1000 μm layout area. A TSP heuristic was applied to connect them using a minimum length loop as it is shown in FIG. 5. The driver 2 of the net can be found in the middle of the described area.

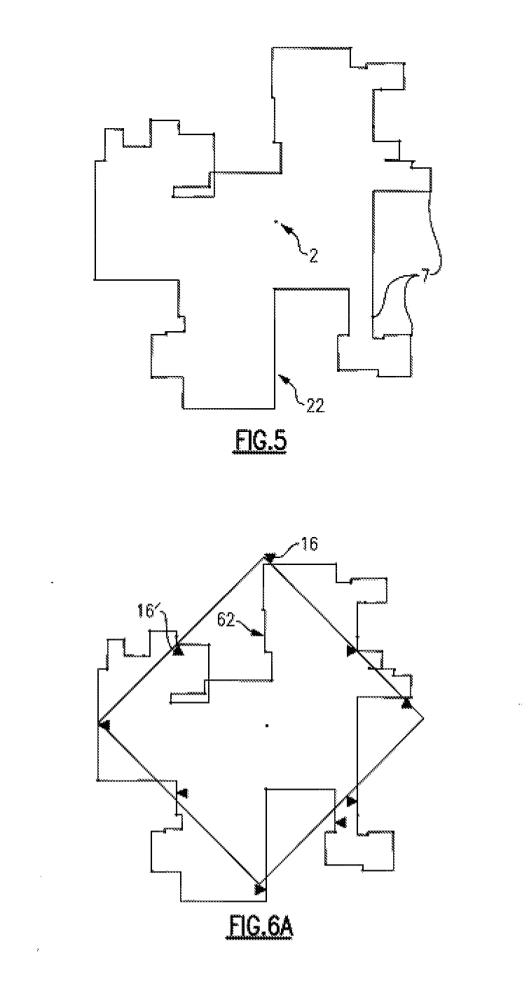

To connect the signal source 2 to the loop the unit circle in the L1-norm (the vector norm of the L1 space as used in mathematics) was used to determine a set of candidates for repeater positions which can be connected to the signal source with an equal amount of wire length. From that set some positions were searched that lie on the loop and have roughly the equal amount of wire length between them which is done to minimize the short circuit current, as described above. This procedure is shown in FIG. 6A. A number of 9 repeater positions marked by triangle in FIG. 6, were found. All positions are on the unit circle in the L1-norm/see the square around the signal source. This ensures that the repeaters can be connected to the signal source with an equal amount of wire length.

Therefore, every repeater has to drive an average of 3.78 signal sinks. The driver size of the repeaters was determined to achieve a certain slew time at the sinks. Note, that the signal delays with the design method are almost equal from the driver to each receiver.

FIG. 6B shows a possible repeater placement if orthogonal and diagonal routing is allowed. The square becomes an octagon.

An analogue simulation technique was used to simulate this test case. The setup thereof was modelled using a linear model for the wires and a transistor level model for the inverters which were used as repeaters. The inverter models are from an IBM 130 nm copper-technology. As circuit simulator the “hSpice” product commercially available from Synopsys was used.

Two experiments were done. First, the worst case short circuit current was to be determined. Two worst case scenarios were examined which are susceptible to the degradation of active devices and wires. In the second experiment the power dissipation was determined to be dependent on a certain distribution of signal arrival times at the inverter inputs.

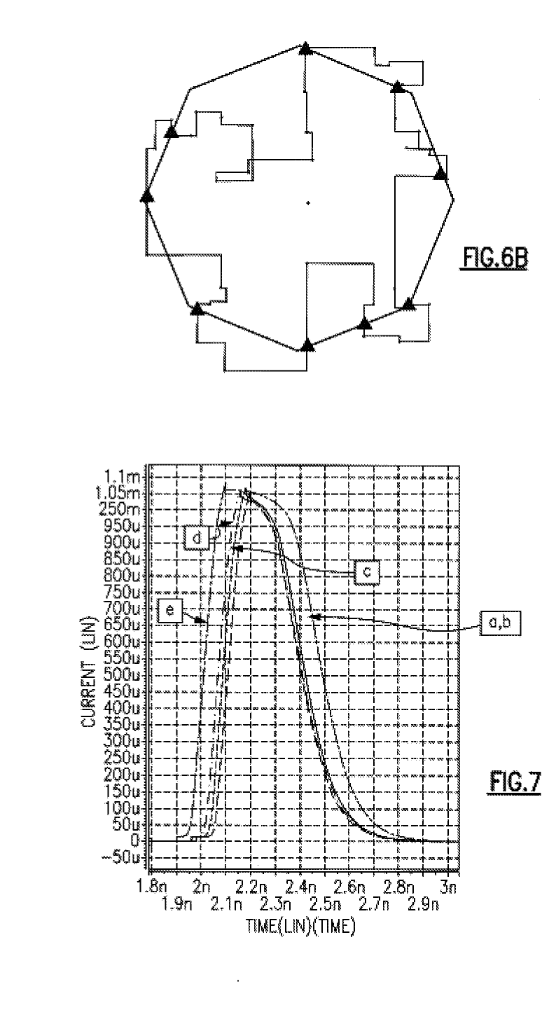

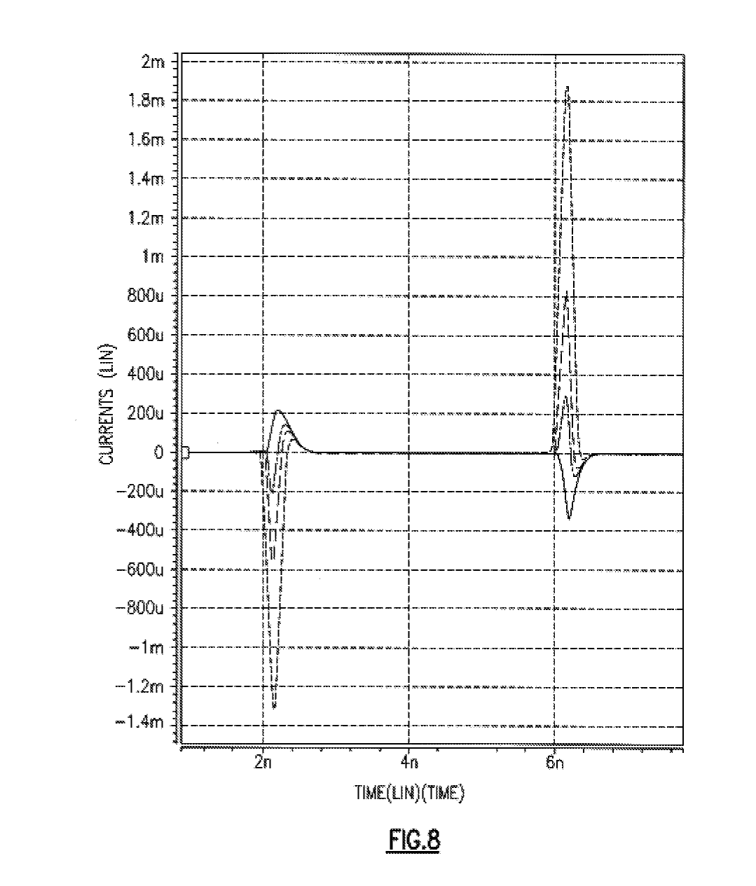

First, and with reference to FIGS. 7 and 8, the analysis on the worst case short circuit current is described next below: If two repeaters are connected at their outputs on a signal path propagating the same signal and are driven with a certain skew, i.e., difference in the signal arrival time at their inputs, this will cause a current flowing from vdd to Gnd. The current flows through the pull-up transistor of one inverter through a piece of wire and through the pull-down transistor of another inverter. This current, which is dependent on the skew, may cause severe device and wire degradation if it exceeds a certain limit.

If there are multiple inverters connected at their outputs switching with distributed arrival times at their inputs, the current path can not be determined. Therefore, worst case scenarios were examined to ensure that even in those unrealistic cases the degradation is avoided.

To determine the worst case an upper bound on the skew must be found. Thus, a few assumptions have to be made: For the test case it was assumed that all inverters can be connected to the signal source with an equal amount of wire length. Hence, there is no systematic skew coming from the wiring. An estimation of 450 μm of wiring lengths was assumed for each connection (not depicted for increasing the clarity) of an inverter to the signal source. Parasitic capacitance and resistance values of Rₙₒₙ=144 ohm, Cₙₒₙ=105.345 fF were assumed. To calculate the signal delay caused by the wiring the Elmore delay estimate T_{D,non}=(R_{drv}+Rₙₒₙ)Cₙₒₙ+8R_{drv}Cₙₒₙ was used. Further, a strong driving inverter with R_{drv}=40 ohm was assumed.

Applying these assumptions the nominal signal delay from the signal source to each inverter was calculated to yield T_{D,non}=52 ps. Input to the simulation was an assumed 30% variation of R and C which are used to calculate the corner values for the delay. Evaluating the Elmore delay estimate for the fast and the slow corner values of T_{D,fast}=34 ps and T_{D,slow}=74.9 ps sire obtained.

If one wire varies in the fast corner and another one in the slow corner we will have an upper bound of 40.9 ps on the skew due to wire variation.

The worst case short circuit current for an inverter will occur if the signal arrives early at this inverter and late at all other inverters. Assuming that there is the same wire length from the signal source to each inverter driving the loop the worst case will happen if the path to one inverter lies in the fast corner and the path to all other inverters are situated in the slow corner. To model this situation voltage sources were connected with a ramped output signal with 200 ps slew time to the input of the inverters in the loop. One voltage source was switching early and the inverter connected to it was situated in the fast corner. All other sources were switching with a defined delay and all inverters connected to them were situated in the slots corner. Vdd was 1.8V. To model the receiving load capacitances with 6 fF were connected to the loop. The current waveforms in the inverter are depicted in FIG. 7

FIG. 7 thus depicts the worst case switching currents through a transistor dependent on the skew. The timescale is 100 ps per scale unit (between two dotted lines). The following short circuit currents were determined dependent of different skews:

(a) 0 ps skew, Iₚₑₐₖ=1.05 mA

(b) Loop disconnected, Iₚₑₐₖ=1.05 mA

(c) 40 ps skew, Iₚₑₐₖ=1.06 mA

(d) 80 ps skew, Iₚₑₐₖ=1.07 mA

(e) 200 ps skews, Iₚₑₐₖ=1.08 mA

In order to show that no short circuit current will flow if there is no skew, the loop was disconnected to separate the early switching circuit from the late switching ones. As FIG. 7 depicts, the current waveforms of the disconnected loop and the waveform with no skew at the inverter inputs are identical. Additionally, FIG. 7 shows that the peak current increases just slightly. The currents are flowing longer because the output voltage is kept on the inverse logical value by the other inverters. Therefore, the current provided by the first switching inverter just causes power dissipation. Assuming that the skew is below 40 ps the waveform change is very all. The peak current is flowing when the output voltage is either vdd or Gnd. The worst HCI (hot carrier injection) effects usually occur if the output voltage is vdd/2 which is not the case. The waveforms for 80 ps and 200 ps are depicted to give an impression on the extremes. Unusual device degradation is not expected.

To examine degradation effects on the wires a worst case for the highest currents in a wire was set up. The worst case short circuit current for a wire will occur it the first half of the loop inverters switches early and the second half switches late. The inverters switch clustered which means that all inverters belonging to one of the sets are adjacent in the loop. Therefore, the resulting current will superpose in the wires connecting both sets. To model this situation the set of drivers was separated into one set that switches early and one set that switches with a certain delay. The current was measured in the wires connecting both sets. The simulation results are depicted in FIG. 8.

FIG. 8 a shows the current flowing through a wire that connects a cluster of early and a cluster of late switching inverters. The timescale is 2 ns per scale unit (between two dotted lines).

(a) 0 ps skew, Iₚₑₐₖ=340 μA

(b) 40 ps skew, Iₚₑₐₖ=300 μA

(c) 80 ps skew, Iₚₑₐₖ=824 μA

(d) 200 ps skew, Iₚₑₐₖ=1.88 mA

(e) 200 ps skews, Iₚₑₐₖ=1.08 mA

FIG. 8 shows that in the test case the peak current is highly dependent on the skew. For skews below 80 ps the current does not superpose to a critical value. With respect to electromigration it has to be considered that the flowing current has no DC component. Electromigration is a physical effect that occurs in conductors: electric current causes conductor atoms to move which can lead to shorts or opens during the lifetime of a product. The electromigration effect is worst if there is a DC component in the current flow because in this case the atoms preferably move to one direction. Therefore, no degradation is expected for skews below 80 ps.

For skews above 200 ps the current is higher then the transistor peak current. In that case the current flow in the wire reaches peak values that are higher than in single driver nets. That is critical with respect to the degradation of wires due to electromigration, which has to be avoided. Skew values above 80 Ds are avoided by limiting the distance of the inverters from the source and using the cascading of loops as described in FIG. 3 to avoid the accumulation of skew over several stages of the net. Note that this scenario is highly unlikely but shows that there should be no harmful current density if the skew at the inverter inputs is bounded.

Next and with reference to the table of FIG. 9 results on the power dissipation are given as follows: The second experiment illustrates how a variation of the signal arrival time at the inverter inputs affects the power dissipation. In addition to the switching power, additional power dissipation is caused by the short circuit current. A number of 1000 trials of Monte-Carlo simulation were run. The voltage sources were used connected to the inverters to vary the signal arrival times around a nominal value according to a normal distribution. A clock cycle was supplied as input signal to the inverters. Table 1 shows the power taken from the voltage supply during that cycle dependent on the 3-sigma value. The mean value, the best value, and the worst value are depicted.

FIG. 9 shows that the dissipated power increases with a progressive rate. Considering the test case and the above-mentioned worst case consideration a 3-sigma value below 100 ps is realistic. In that region the mean value of the additional power dissipation is below 2%. The worst case within the 1000 runs dissipates 8.07% more power than without skew. If one treats multiple nets on a die with the inventive technique the mean value is relevant fox the overall additional power dissipation. This means that the additional power dissipation coming from the short circuit current effect is nearly negligible for the inventive setup.

It should be noted, that this effect may become worse if the wiring to the inverter inputs increases in length for larger nets or multiple inverter stages. This issue will be addressed by the shortening of previous stages as shown in FIG. 3. If there is unwanted skew at the input of multiple driving circuits, a known technique to reduce the skew is the shortening of its outputs. Therefore, it is always possible to trade off skew for power. If the worst case skew at the inverter inputs is above the defined threshold, the solution is to insert an additional repeater stage as it is shown in FIG. 3.

The present invention can be realized in hardware, software, i.e., the simulation part of the invention), or a combination of hardware and software.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following

a) conversion to another language, code or notation;

b) reproduction in a different material form.

1. A method for designing fan-out nets in an integrated circuit, said fan-out nets connecting a signal source and a plurality of active net elements, the method characterized by the steps of:
a) implementing a routing section in a closed structure comprising a plurality of signal receiving pins, wherein said receiving pins connect to further of said active net elements;
b) implementing on said closed structure a plurality of buffer elements around the source pin to provide multiple signals derived from said source signal for driving said plurality of active net elements; and
c) locating two buffer elements along connective wiring at a distance from each other greater than a predetermined minimum wiring length in order to keep a short circuit current tolerably small.

2. The method according to claim 1, wherein said closed structure is obtained from a prior art design step and has minimum wire length.

3. The method according to claim 1, wherein locations of said buffers are basically evenly spaced from each other, thus defining inter-butter wiring of basically a single same length.

4. The method according to claim 1, wherein said closed structure is located in close proximity to said source.

5. The method according to claim 1, wherein steps a) and b) of claim 1 are used in an iterated form.

6. A tool for designing fan-out nets in an integrated circuit, said fan-out nets connecting a signal source and a plurality of active net elements, the design tool comprising a functional component for performing the steps of:
a) implementing a routing section in a closed structure comprising a plurality of signal receiving pins, wherein said receiving pins connect to further active net elements;
b) implementing on said closed structure a plurality of buffer elements around the source pin to provide multiple signals derived from said source signal for driving said plurality of active net elements; and
c) locating two buffer elements along connective wiring at a distance from each other greater than a predetermined minimum wiring length in order to keep a short circuit current tolerably small.

7. A data processing system comprising a chip designed according to a method of the claim 1.

8. A computer program product for designing fan-out nets in an integrated circuit, said fan-out nets connecting a signal source and a plurality of active net elements the computer program product having a functional component for performing the steps of:
a) implementing a routing section in a closed structure comprising a plurality of signal receiving pins, wherein said receiving ping connect to further active net elements,
b) implementing on said closed structure a plurality of buffer elements around the source pin to provide multiple signals derived from said source signal for driving said plurality of active net elements, and
c) locating two buffer elements along connective wiring at a distance from each other greater than a predetermined minimum wiring length in order to keep a short circuit current tolerably small.
